(19) United States
(12) Patent Application Publication
(10) Pub. No.: US 2025/0317514 A1
(43) Pub. Date: Oct. 9, 2025

(54) DETERMINING WHETHER AND/OR WHEN TO CAUSE AUTOMATED ASSISTANT(S) TO INITIATE AND CONDUCT AUTOMATED TELEPHONE CALL(S)

(71) Applicant: GOOGLE LLC, Mountain View, CA (US)

(72) Inventor: Sasha Goldshtein, Tel Aviv (IL)

(21) Appl. No.: 18/630,415

(22) Filed: Apr. 9, 2024

(51) Int. Cl. H04M 3/51; G10L 13/02; G10L 15/22; G10L 15/30

(52) U.S. Cl. CPC H04M 3/5133; G10L 13/02; G10L 15/22; G10L 15/30; H04M 3/5191; G10L 2015/223; H04M 2201/39; H04M 2201/42

(57) ABSTRACT

In various implementations, processor(s) of a system can receive user input to cause an automated assistant to initiate an automated telephone call. Based on the user input, the processor(s) can identify an entity to engage with during the automated telephone call and a task to be performed during the automated telephone call. However, and prior to causing the automated assistant to initiate the automated telephone call, the processor(s) obtain data that is associated with the entity to engage with during the automated telephone call and that is relevant to the task to be performed during the automated telephone call. In some implementations, the processor(s) can determine whether to initiate the automated telephone call based on the data. In additional or alternative implementations, the processor(s) can determine when to initiate the automated telephone call based on the data.

### BACKGROUND

Humans may engage in human-to-computer dialogs with interactive software applications referred to as “chatbots,” “automated assistants”, “intelligent personal assistants,” etc. (referred to herein as “automated assistants”). As one example, these automated assistants may correspond to a machine learning model or a combination of different machine learning models and may be utilized to perform various tasks on behalf of users. For instance, some of these automated assistants can initiate telephone calls and conduct conversations with various human users or other automated assistants during the telephone calls to perform task(s) on behalf of the users (referred to herein as “automated telephone calls”). In performing these automated telephone calls, these automated assistants can cause corresponding instances of synthesized speech to be rendered at a corresponding client device of the various human users and receive instances of corresponding responses from the various human users. Based on the instances of the synthesized speech and/or the instances of the corresponding responses, these automated assistants can determine a result of performance of the task(s) and cause an indication of the result of the performance of the task(s) to be provided for presentation to the users.

However, in some instances, these automated assistants may be capable of performing some task(s) that are requested to be performed by a user and during automated telephone call(s), and without having to initiate and conduct the automated telephone call(s). For example, assume that a given user invokes an automated assistant at a corresponding client device and requests that the automated assistant call Hypothetical Café—a fictitious restaurant entity—to ask whether there is currently a wait time to dine at Hypothetical Café. In this example, the automated assistant may be capable of utilizing data that is readily available, such as wait time statistics for Hypothetical Café that are accessible via the Internet for different intervals of time, to determine that it is highly unlikely that there is currently a wait time to dine at Hypothetical Café. Nonetheless, in this example, and even though the automated assistant is capable of utilizing the data that is readily available to perform the task and without having to initiate and conduct the automated telephone call, the automated assistant may still initiate and conduct the automated telephone call to determine whether there is currently a wait time to dine at Hypothetical Café based on the user's request to do so, thereby wasting computational and/or network resources.

In other instances, and even assuming that the automated assistant is not capable of performing some task(s) without having to initiate and conduct the automated telephone call(s), the automated assistant may not initiate the automated telephone call at an appropriate time. While some automated assistants are capable of refraining from initiating and conducting the automated telephone call(s) until hours of operation of an entity indicate that the entity is open for business, these automated assistants fail to consider other factors in attempting to initiate and conduct the automated telephone call(s). For example, assume that a given user invokes an automated assistant at a corresponding client device at 7:00 PM on the current day and requests that the automated assistant call Hypothetical Café—a fictitious restaurant entity—to make dinner reservations for 6:00 PM the next day at Hypothetical Café. In this example, the automated assistant may also be capable of utilizing data that is readily available, such as busy time statistics for Hypothetical Café that are accessible via the Internet for different intervals of time, to determine that it is highly likely that a receptionist or other representative at Hypothetical Café may be too busy with customers in-person to answer the automated telephone call. Nonetheless, in this example, the automated assistant may still initiate and conduct the automated telephone call to make the reservation simply because the hours of operation of Hypothetical Café indicate that it is currently open for business. Nonetheless, in this example, and even though the automated assistant is capable of utilizing the data that is readily available to determine it is unlikely the receptionist or other representative at Hypothetical Café will answer the automated telephone call, the automated assistant may still initiate and conduct the automated telephone call in an attempt to make the reservation, thereby wasting computational and/or network resources.

Accordingly, there is a need in the art for techniques to more intelligently determine whether to initiate automated telephone call(s) and/or when to initiate automated telephone call(s), thereby conserving computational and/or network resources that are otherwise wasted.

### SUMMARY

Implementations described herein are directed to determining whether and/or when to cause automated assistant(s) to initiate automated telephone call(s). For example, processor(s) of a system can receive user input to initiate an automated telephone call, identify an entity to engage with during the automated telephone call and based on the user input, identify a task to be performed by the automated assistant during the automated telephone call and based on the user input, and obtain data that is associated with the entity to engage with during the automated telephone call and that is relevant to the task to be performed by the automated assistant during the automated telephone call. The processor(s) can utilize the data that is associated with the entity to engage with during the automated telephone call and that is relevant to the task to be performed by the automated assistant during the automated telephone call in determining whether to cause the automated assistant to initiate the automated telephone call and/or when to cause the automated assistant to initiate the automated telephone call.

In some implementations, the processor(s) can determine whether to initiate the automated telephone call or to refrain from initiating the automated telephone call and based on the data that is associated with the entity to engage with during the automated telephone call and that is relevant to the task to be performed by the automated assistant during the automated telephone call. In these implementations, and in response to determining to refrain from initiating the automated telephone call, the processor(s) can generate a notification that includes an indication of a certain reason with respect to why the automated assistant refrained from initiating the automated telephone call, and can cause the notification to be rendered (e.g., visually rendered and/or audibly rendered) for presentation to the user via the client device. In additional or alternative implementations, the processor(s) can determine a given time instance to initiate the automated telephone call within hours of operation of the entity and based on the data that is associated with the entity to engage with during the automated telephone call and that is relevant to the task to be performed by the automated assistant during the automated telephone call. In these implementations, and in response to determining that a current time instance corresponds to the given time instance, the processor(s) can cause the automated assistant to initiate the automated telephone call and can cause the automated assistant to conduct the automated telephone call.

Accordingly, implementations described herein can conserve computational and/or network resources when the processor(s) utilize the data to perform the task and without causing the automated assistant to initiate and conduct the automated telephone call. Further, and even assuming the processor(s) determine to initiate and conduct the automated telephone call, implementations described herein can conserve computational and/or network resources when the processor(s) determine a given time instance (e.g., within hours of operation of the entity) to initiate and conduct the automated telephone call to maximize the likelihood that the automated assistant will successfully perform the task. These computational and/or network resources can include, for example, telephonic network resources consumed by the processor(s) causing the automated assistant to initiate and/or conduct the automated telephone call, computational and/or network resources consumed by the processor(s) causing the automated assistant to initiate and/or conduct the automated telephone call, and/or other computational and/or network resources.

For example, assume that a given user invokes an automated assistant at a corresponding client device and requests that the automated assistant call Hypothetical Café—a fictitious restaurant entity—to ask whether there is currently a wait time to dine at Hypothetical Café. In this example, the automated assistant may identify Hypothetical Café as the entity and may identify a task of inquiring about a wait time at Hypothetical Café. However, rather than immediately initiating the automated telephone call directed to Hypothetical Café to inquire about a wait time, the automated assistant may obtain data that is associated with Hypothetical Café and that is relevant to wait times at Hypothetical Café. For instance, the automated assistant can obtain wait time statistics for Hypothetical Café that are available via the Internet. Further assume that the wait time statistics for Hypothetical Café that are obtained indicate that Hypothetical Café is usually very busy at a current time. Accordingly, and in lieu of initiating the automated telephone call, the automated assistant can generate a notification that indicates the wait time statistics for Hypothetical Café indicate that Hypothetical Café is usually not busy at a current time and cause the notification to be visually and/or audibly rendered at the client device, thereby conserving computational and/or network resources.

In some implementations, the notification that is generated can include a selectable element that, when selected, causes the automated assistant to initiate and conduct the automated telephone call. Continuing with the above example, the user can provide a user selection (e.g., voice selection, touch selection, etc.) directed to the selectable element to override the initial determination made by the automated assistant. Accordingly, in this example, the automated assistant can initiate and conduct the automated telephone call. In additional or alternative implementations, the notification that is generated can include a selectable link that, when selected, causes the automated assistant to navigate to the data that is associated with the entity to engage with during the automated telephone call and that is relevant to the task to be performed by the automated assistant during the automated telephone call. Continuing with the above example, the user can provide a user selection (e.g., voice selection, touch selection, etc.) directed to the selectable link to navigate to the wait time statistics for Hypothetical Café. Accordingly, in this example, the automated assistant can utilize a web browser software application, a navigation software application, or the like to navigate to a source of the wait time statistics to the user.

In some implementations, and in obtaining the data that is associated with the entity to engage with during the automated telephone call and that is relevant to the task to be performed by the automated assistant during the automated telephone call, the processor(s) can cause the automated assistant to search, over one or more databases, for entity data associated with the entity to engage with during the automated telephone call, and can cause the automated assistant to search, over the entity data included in one or more of the databases, for task data that is specific to the entity and that is relevant to the task to be performed by the automated assistant during the automated telephone call. Put another way, the processor(s) can initially restrict a search space for the data based on the entity that is identified based on the user input, and then search the restricted search space based on the task that is identified based on the user input. Continuing with the above example, the automated assistant can initially search the Internet for data associated with Hypothetical Café, and then search the data that is obtained for Hypothetical Café for data associated with wait time statistics associated with Hypothetical Café. In this manner, the automated assistant can more efficiently search for the data.

Although the above example is described with respect to the data that is associated with the entity to engage with during the automated telephone call and that is relevant to the task to be performed by the automated assistant during the automated telephone call being wait time statistics, it should be understood that is for the sake of example and is not meant to be limiting. Rather, it should be understood that the data that is associated with the entity to engage with during the automated telephone call and that is relevant to the task to be performed by the automated assistant during the automated telephone call is dependent on an entity type of the entity, a task type of the task, and/or other criteria. Some non-limiting example of the data that is associated with the entity to engage with during the automated telephone call and that is relevant to the task to be performed by the automated assistant during the automated telephone call include: busy time statistics associated with how long a busy is the entity is at a given time instance, wait time statistics associated with how long a wait associated with the entity is at the given time instance, pecuniary statistics associated with pecuniary information for the entity, hours of operation information that includes hours of operation of the entity for a given time period, review information that includes information about the entity that is provided by other users, image information that includes images about the entity of the entity that is provided by other users, and/or other data associated with the entity and that is relevant to the task.

As another example, assume that a given user invokes an automated assistant at a corresponding client device at 6:00 PM on the current day and requests that the automated assistant call Hypothetical Café—a fictitious restaurant entity—to make dinner reservations for 6:00 PM at the next day at Hypothetical Café. In this example, the automated assistant may identify Hypothetical Café as the entity and may identify a task of making a reservation at Hypothetical Café. However, rather than immediately initiating the automated telephone call directed to Hypothetical Café to make the reservation, the automated assistant may obtain data that is associated with Hypothetical Café and that is relevant to busy times at Hypothetical Café. For instance, the automated assistant can obtain busy time statistics for Hypothetical Café that are available via the Internet. Further assume that the busy time statistics for Hypothetical Café that are obtained indicate that Hypothetical Café is usually very busy at a current time. Accordingly, and in lieu of immediately initiating the automated telephone call, the automated assistant can generate a notification that indicates the busy time statistics for Hypothetical Café indicate that Hypothetical Café is very busy at a current time and unlikely to answer the automated telephone call so the automated assistant will call at a later time, and cause the notification to be visually and/or audibly rendered at the client device, thereby conserving computational and/or network resources. For instance, rather than initiating the automated telephone call with Hypothetical Café when it is very busy, the automated assistant can call at a later time or the next morning when Hypothetical Café is less busy and more likely to answer the automated telephone call.

In some implementations, the notification that is generated can include a selectable element that, when selected, causes the automated assistant to immediately initiate and conduct the automated telephone call. Continuing with the above example, the user can provide a user selection (e.g., voice selection, touch selection, etc.) directed to the selectable element to override the initial determination made by the automated assistant. Accordingly, in this example, the automated assistant can initiate and conduct the automated telephone call. In additional or alternative implementations, the notification that is generated can include a selectable link that, when selected, causes the automated assistant to navigate to the data that is associated with the entity to engage with during the automated telephone call and that is relevant to the task to be performed by the automated assistant during the automated telephone call. Continuing with the above example, the user can provide a user selection (e.g., voice selection, touch selection, etc.) directed to the selectable link to navigate to the busy time statistics for Hypothetical Café. Accordingly, in this example, the automated assistant can utilize a web browser software application, a navigation software application, or the like to navigate to a source of the busy time statistics to the user.

In some implementations, and in obtaining the data that is associated with the entity to engage with during the automated telephone call and that is relevant to the task to be performed by the automated assistant during the automated telephone call, the processor(s) can cause the automated assistant to search, over one or more databases, in the same or similar manner described above. Further, although the above example is described with respect to the data that is associated with the entity to engage with during the automated telephone call and that is relevant to the task to be performed by the automated assistant during the automated telephone call being busy time statistics, it should be understood that is for the sake of example and is not meant to be limiting. Rather, and as noted above, it should be understood that the data that is associated with the entity to engage with during the automated telephone call and that is relevant to the task to be performed by the automated assistant during the automated telephone call is dependent on the entity type of the entity, the task type of the task, and/or other criteria.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts an example process flow using various components from the example environment from FIG. 1, in accordance with various implementations.

FIG. 3 depicts a flowchart illustrating an example method of dynamically determining whether to initiate an automated telephone call, in accordance with various implementations.

FIG. 4 depicts a flowchart illustrating an example method of dynamically determining when to initiate an automated telephone call, in accordance with various implementations.

FIG. 5A and FIG. 5B depict various non-limiting examples of determining whether to initiate an automated telephone call, in accordance with various implementations.

FIG. 6A and FIG. 6B depict various non-limiting examples of determining when to initiate an automated telephone call, in accordance with various implementations.

FIG. 7 depicts an example architecture of a computing device, in accordance with various implementations.

### DETAILED DESCRIPTION

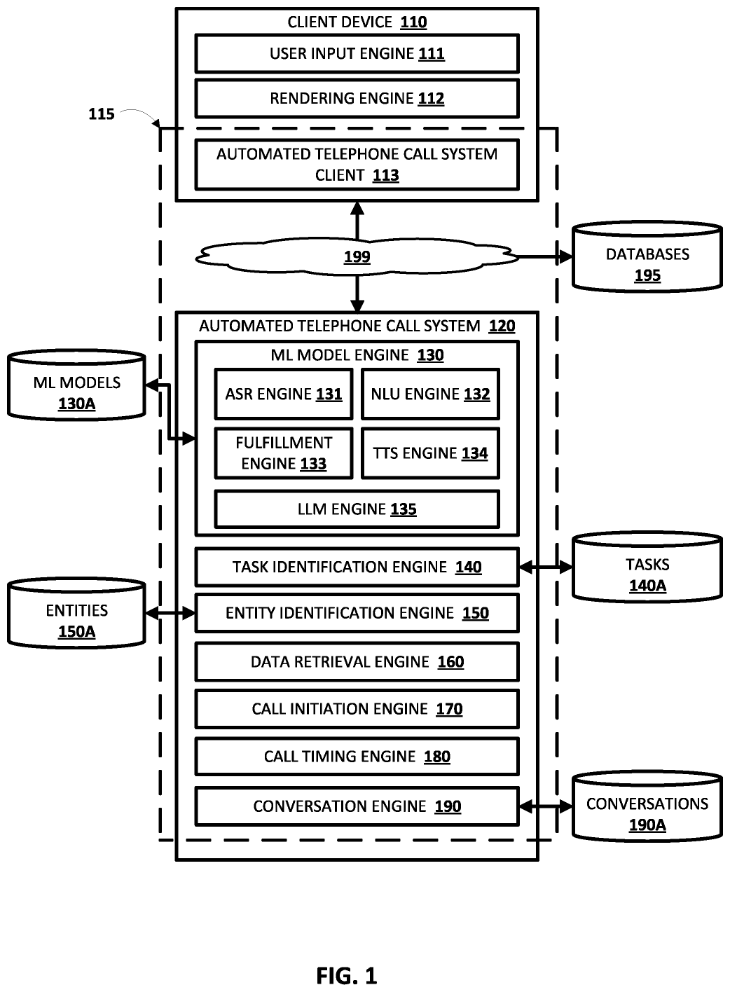

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and an automated telephone call system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a dialog between a user of the client device 110 and an automated assistant 115 executing at least in part at the client device 110, a transcript of a dialog between the automated assistant 115 executing at least in part at the client device 110 and an additional user that is in addition to the user of the client device 110, notifications, selectable graphical elements, and/or any other content and/or output described herein.

Further, the client device 110 is illustrated in FIG. 1 as communicatively coupled, over one or more networks 199 (e.g., any combination of Wi-Fi®, Bluetooth®, or other local area networks (LANs); ethernet, the Internet, or other wide area networks (WANs); and/or other networks), to an automated telephone call system 120. The automated telephone call system 120 can be, for example, a high-performance server, a cluster of high-performance servers, and/or any other computing device that is remote from the client device 110. The automated telephone call system 120 includes, in various implementations, a machine learning (ML) model engine 130, a task identification engine 140, an entity identification engine 150, a data retrieval engine 160, a call initiation engine 170, a call timing engine 180, and a conversation engine 190. The ML model engine 130 can include various sub-engines, such as an automatic speech recognition (ASR) engine 131, a natural language understanding (NLU) engine 132, a fulfillment engine 133, a text-to-speech (TTS) engine 134, and a large language model (LLM) engine 135. These various sub-engines can utilize one or more respective ML models (e.g., stored in ML models database 130A).

The automated telephone call system 120 can leverage various databases. For instance, and as noted above, the ML model engine 130 can the leverage ML models database 130A that stores various ML models; the task identification engine 140 can leverage tasks database 140A that stores various tasks, parameters associated with the various tasks, entities that can be interacted with to perform the various tasks; the entity identification engine 150 can leverage entities database 150A that stores various entities; and the conversation engine 190 can leverage conversations database 190A that stores various conversations between users, users and automated assistants, between automated assistants, and/or other conversations. Although FIG. 1 is depicted with respect to certain engines and/or sub-engines of the automated telephone call system 120 having access to certain databases, it should be understood that is for the sake of example and is not meant to be limiting.

Moreover, the client device 110 can execute the automated telephone call system client 113. An instance of the automated telephone call system client 113 can be an application that is separate from an operating system of the client device 110 (e.g., installed “on top” of the operating system)—or can alternatively be implemented directly by the operating system of the client device 110. The automated telephone call system client 113 can implement the automated telephone call system 120 locally at the client device 110 and/or remotely from the client device 110 via one or more of the networks 199 (e.g., as shown in FIG. 1). The automated telephone call system client 113 (and optionally by way of its interactions with the automated telephone call system 120) may form what appears to be, from a user's perspective, a logical instance of aspects of an automated assistant 115 with which the user may engage in a human-to-computer dialog and with which the user can cause automated telephone calls to be initiated on behalf of the user. An instance of the automated assistant 115 is depicted in FIG. 1 and is encompassed by a dashed line that includes the automated telephone call system client 113 of the client device 110 and the automated telephone call system 120.

Furthermore, the client device 110 and/or the automated telephone call system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

As described herein, the automated telephone call system 120 can be utilized to intelligently determine whether and/or when to initiate phone conversations via the automated assistant 115 in an effort to conserve computational resources and/or network resources. For example, in intelligently determining whether to initiate the automated telephone phone call via the automated assistant 115, the automated telephone call system 120 can determine to refrain from causing the automated assistant 115 to initiate and conduct automated telephone calls to perform a task on behalf of a user in instances when data is readily available (but unknown to the user) that can utilized to satisfy performance of the task. In this example, the automated assistant can obtain the data and provide it for presentation to the user, thereby obviating a need to initiate and conduct the automated telephone call using various ML model(s) (e.g., which are computationally intensive). As a result, telephonic network resources are conserved and computational resources (e.g., of the client device 110 and/or the automated telephone call system 120) and/or network resources are conserved.

Additionally, or alternatively, and assuming the automated telephone call system 120 determines to cause the automated assistant 115 to initiate and conduct automated telephone call, in determining when to initiate the automated telephone phone call via the automated assistant 115, the automated telephone call system 120 can determine a given time instance within operating hours of an entity to engage with during the automated telephone call to initiate the automated telephone call. The given time instance determined by the automated telephone call system 120 can be, for instance, an optimal time to initiate and conduct the automated telephone call to maximize a likelihood of successfully completing the task to be performed during the automated telephone call, thereby obviating instances of automated telephone calls being performed at suboptimal times. As a result, telephonic network resources, computational resources (e.g., of the client device 110 and/or the automated telephone call system 120), and/or network resources are selectively utilized, thereby resulting in conservation thereof.

The automated telephone calls described herein can be conducted by the automated assistant 115. For example, the automated telephone calls can be conducted using Voice over Internet Protocol (VoIP), public switched telephone networks (PSTN), and/or other telephonic communication protocols. Further, the automated telephone calls described herein are automated in that the automated assistant 115 conducts the automated telephone calls using one or more of the components depicted in FIG. 1, on behalf of a user of the client device 110, and the user of the client device 110 is not an active participant in the automated telephone call(s).

In various implementations, the ASR engine 131 can process, using ASR model(s) stored in the ML models database 130A (e.g., a recurrent neural network (RNN) model, a transformer model, and/or any other type of ML model capable of performing ASR), audio data that captures a spoken utterance and that is generated by microphone(s) of the client device 110 (or microphone(s) of an additional client device) to generate ASR output. Further, the NLU engine 132 can process, using NLU model(s) stored in the ML models database 130A (e.g., a long short-term memory (LSTM), gated recurrent unit (GRU), and/or any other type of RNN or other ML model capable of performing NLU) and/or NLU rule(s), the ASR output (or other typed or touch inputs received via the user input engine 111 of the client device 110) to generate NLU output. Moreover, the fulfillment engine 133 can process, using fulfillment model(s) and/or fulfillment rules stored in the ML models database 130A, the NLU data to generate fulfillment output. Additionally, the TTS engine 134 can process, using TTS model(s) stored in the ML models database 130A, textual content (e.g., text formulated by the automated assistant 115) to generate synthesized speech audio data that includes computer-generated synthesized speech. Furthermore, in various implementations, the LLM engine 135 can replace one or more of the aforementioned components. For instance, the LLM engine 135 can replace the NLU engine 132 and/or the fulfillment engine 133. In these implementations, the LLM engine 135 can process, using LLM(s) stored in the ML models database 130A (e.g., PaLM, BARD, BERT, LaMDA, Meena, GPT, and/or any other LLM, such as any other LLM that is encoder-only based, decoder-only based, sequence-to-sequence based and that optionally includes an attention mechanism or other memory), the ASR output (or other typed or touch inputs received via the user input engine 120 of the client device 110) to generate LLM output.

In various implementations, the ASR output can include, for example, a plurality of speech hypotheses (e.g., term hypotheses and/or transcription hypotheses) that are predicted to correspond to spoken utterance(s) based on the processing of audio data that captures the spoken utterance(s). The ASR engine 131 can optionally select a particular speech hypotheses as recognized text for the spoken utterance(s) based on a corresponding value associated with each of the plurality of speech hypotheses (e.g., probability values, log likelihood values, and/or other values). In various implementations, the ASR model(s) stored in the ML model(s) database 130A are end-to-end speech recognition model(s), such that the ASR engine 131 can generate the plurality of speech hypotheses directly using the ASR model(s). For instance, the ASR model(s) can be end-to-end model(s) used to generate each of the plurality of speech hypotheses on a character-by-character basis (or other token-by-token basis). One non-limiting example of such end-to-end model(s) used to generate the recognized text on a character-by-character basis is a recurrent neural network transducer (RNN-T) model. An RNN-T model is a form of sequence-to-sequence model that does not employ attention mechanisms or other memory. In other implementations, the ASR model(s) are not end-to-end speech recognition model(s) such that the ASR engine 131 can instead generate predicted phoneme(s) (and/or other representations). For instance, the predicted phoneme(s) (and/or other representations) may then be utilized by the ASR engine 131 to determine a plurality of speech hypotheses that conform to the predicted phoneme(s). In doing so, the ASR engine 131 can optionally employ a decoding graph, a lexicon, and/or other resource(s). In various implementations, a corresponding transcription that includes the recognized text can be rendered at the client device 110.

In various implementations, the NLU output can include, for example, annotated recognized text that includes one or more annotations of the recognized text for one or more (e.g., all) of the terms of the recognized text. For example, the NLU engine 132 may include a part of speech tagger (not depicted) configured to annotate terms with their grammatical roles. Additionally, or alternatively, the NLU engine 132 may include an entity tagger (not depicted) configured to annotate entity references in one or more segments of the recognized text, such as references to people (including, for instance, literary characters, celebrities, public figures, etc.), organizations, locations (real and imaginary), and so forth. In some implementations, data about entities may be stored in one or more databases, such as in a knowledge graph (not depicted). In some implementations, the knowledge graph may include nodes that represent known entities (and in some cases, entity attributes), as well as edges that connect the nodes and represent relationships between the entities. The entity tagger may annotate references to an entity at a high level of granularity (e.g., to enable identification of all references to an entity class such as people) and/or a lower level of granularity (e.g., to enable identification of all references to a particular entity such as a particular person). The entity tagger may rely on content of the natural language input to resolve a particular entity and/or may optionally communicate with a knowledge graph or other entity database to resolve a particular entity. Additionally, or alternatively, the NLU engine 132 may include a coreference resolver (not depicted) configured to group, or “cluster,” references to the same entity based on one or more contextual cues. For example, the coreference resolver may be utilized to resolve the term “them” to “buy theatre tickets” in the natural language input “buy them”, based on “theatre tickets” being mentioned in a client device notification rendered immediately prior to receiving input “buy them”. In some implementations, one or more components of the NLU engine 132 may rely on annotations from one or more other components of the NLU engine 132. For example, in some implementations the entity tagger may rely on annotations from the coreference resolver in annotating all mentions to a particular entity. Also, for example, in some implementations, the coreference resolver may rely on annotations from the entity tagger in clustering references to the same entity. Also, for example, in some implementations, the coreference resolver may rely on user data of the user of the client device 110 in coreference resolution and/or entity resolution. The user data may include, for example, historical location data, historical temporal data, user preference data, user account data, calendar information, email data, and/or any other user data that is accessible at the client device 110.

In various implementations, the fulfillment output can include, for example, one or more tasks to be performed by the automated assistant 115. For example, the user can provide unstructured free-form natural language input in the form of spoken utterance(s). The spoken utterance(s) can include, for instance, an indication of the one or more tasks to be performed by the automated assistant 115. The one or more tasks may require the automated assistant 115 to provide certain information to the user, engage with one or more external systems on behalf of the user (e.g., an inventory system, a reservation system, etc. via a remote procedure call (RPC)), and/or any other task that may be specified by the user and performed by the automated assistant 115. Accordingly, it should be understood that the fulfillment output may be based on the one or more tasks to be performed by the automated assistant 115 and may be dependent on the corresponding conversations with the user.

In various implementations, the TTS engine 134 can generate synthesized speech audio data that captures computer-generated synthesized speech. The synthesized speech audio data can be rendered at the client device 110 via speaker(s) of the client device 110. The synthesized speech may include any output generated by the automated assistant 115 as described herein, and may include, for example, synthesized speech generated as part of a dialog between the user of the client device 110 and the automated assistant 115, as part of an automated telephone call between the automated assistant 115 and a representative associated with an entity (e.g., a human representative associated with the entity, an automated assistant representative associated with the entity, and interactive voice response (IVR) system associated with the entity, etc.), and so on.

In various implementations, the LLM output can include, for example, a probability distribution over a sequence of tokens, such as words, phrases, or other semantic units, that are predicted to be responsive to the spoken utterance(s) or other user inputs provided by the user of the client device 110 and/or other users (e.g., the representative associated with the entity). Notably, the LLM(s) stored in the ML model(s) database 130A can include billions of weights and/or parameters that are learned through training the LLM on enormous amounts of diverse data. This enables these LLM(s) to generate the LLM output as the probability distribution over the sequence of tokens. In these implementations, the LLM engine 135 can replace the NLU engine 132 and/or the fulfillment engine 133 since these LLM(s) can perform the same or similar functionality in terms of natural language processing.

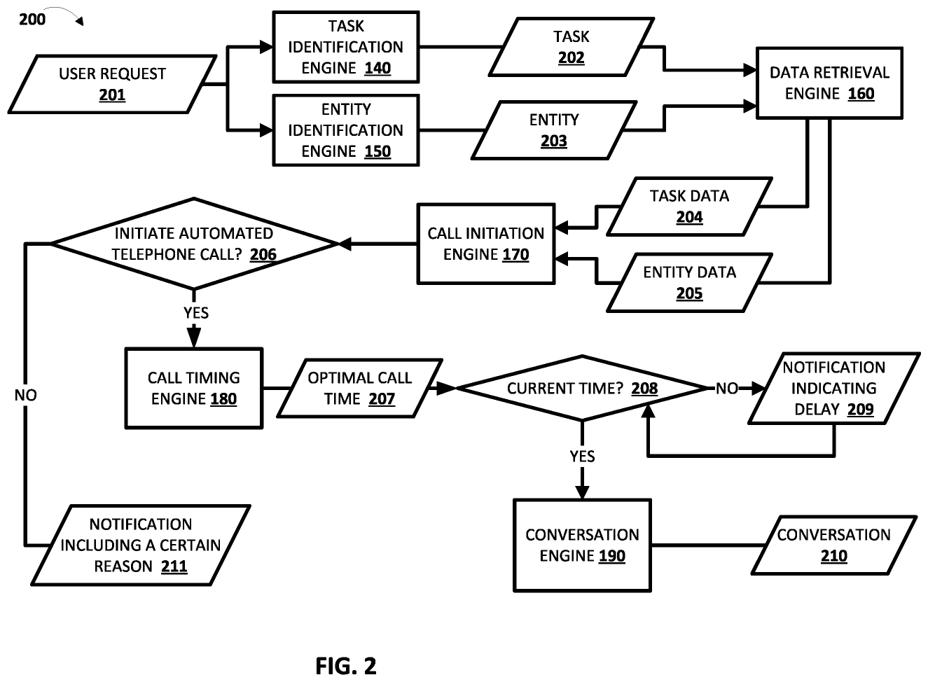

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the automated telephone call system 120 (e.g., over the one or more networks 199). As another example, a given client device can be utilized by multiple users in a shared setting (e.g., a group of users, a household, etc.). Additional descriptions of the task identification engine 140, the entity identification engine 150, the data retrieval engine 160, the conversation initiation engine 170, the conversation timing engine 180, and the conversation engine 190 are provided herein (e.g., with respect to FIGS. 2, 3, and 4).

Referring now to FIG. 2, an example process flow 200 for utilizing various components from the example environment of FIG. 1 is depicted. For the sake of example, assume that the automated assistant 115 receives a user request 201. In some implementations, the automated assistant 115 can receive the user request 201 based on user input that is received from a user of the client device 110. The user input can be, for example, spoken input directed to the automated assistant 115 and captured in audio data generated via microphone(s) of the client device 110, typed and/or touch input directed to the automated assistant 115 and captured in typed and/or touch data generated via a display or other input device of the client device 110, and/or other inputs (e.g., gesture inputs, etc.). In these implementations, the task identification engine 140 can process the user input (or a sequence of user inputs) to identify a task 202 to be performed by the automated assistant (and optionally using data stored in the tasks database 140A) using various ML model(s) described herein (e.g., NLU model(s), fulfillment model(s) or rule(s), LLM(s), etc.). Further, the entity identification engine 150 can process the user input (or the sequence of user inputs) to identify an entity 203 to engage with while fulfilling the received user request 201 (and optionally using data stored in the entities database 150A) using various ML model(s) described herein (e.g., NLU model(s), fulfillment model(s) or rule(s), LLM(s), etc.).

For example, if the user input is “Call Hypothetical Café and make dinner reservations for 6:00 PM the next day”, then the task 202 to be performed can be “initiate an automated telephone call”, “conduct the automated telephone call”, and/or “make dinner reservations at 6:00 PM the next day [for user]”, and the entity 203 can be a brick and mortar location of “Hypothetical Café” that is most geographically proximate to the user, that is typically visited by the user, etc. In these implementations, the automated assistant 115 that initiates the automated telephone call can be implemented locally at the client device 110 (e.g., via the automated telephone call system client 113) or remotely from the client device (e.g., via the automated telephone call system 120).

In additional or alternative implementations, the automated assistant 115 can receive the user request 201 based on other signals that are in addition to user input that is received from a user of the client device 110. The other signals can include, for example, detecting a spike in query activity across a population of client devices in a certain geographical area. In these implementations, the task identification engine 140 can process the query activity to identify a task 202 to be performed while fulfilling the received user request 201. Further, the entity identification engine 150 can process the query activity and the particular geographic area to identify an entity 203 to engage with while fulfilling the received user request 201.

For example, if a plurality of users submit a threshold quantity of queries for “wait times at Hypothetical Café”, and the plurality of users are located within a threshold distance of one another, the threshold quantity of the queries can be considered a spike in query activity. Accordingly, the task 202 to be performed can be “initiate an automated telephone call”, “conduct the automated telephone call”, and “inquire about wait times at Hypothetical Café”, and the entity 203 can be one or more brick and mortar locations of “Hypothetical Café” that are also located within the particular geographic area. In these implementations, the automated assistant 115 that initiates the automated telephone call can be implemented remotely from the client device (e.g., via the automated telephone call system 120).

Subsequent to identifying the entity 203 to engage with and the task 202 to be performed to fulfill the received user request 201, the data retrieval engine 160, can obtain data. The data can include, for example, task data 204 associated with the identified task 202 and/or entity data 205 associated with the identified entity 203. For example, if the entity 203 is identified as “Hypothetical Café”, the data retrieval engine 160 can obtain identifying information specific to Hypothetical Café, such as phone number(s), street address(s), website(s), and/or other identifying information. If task 202 is identified as “inquire about wait times at Hypothetical Café”, the data retrieval engine 160 can obtain various wait time statistics for Hypothetical Café. The task data 204 and entity data 205 can be obtained via one or more of the networks 199 or via information stored in the tasks database 140A and/or the entities database 150A.

The call initiation engine 170 can process the data (e.g., task data 204 and/or entity data 205) to determine whether to initiate an automated telephone call as indicated at 206 with the entity 203. In continuation of the previous example, further assume that the entity data 205 indicates that Hypothetical Café does not take reservations. In this example, the call initiation engine 170 can determine to refrain from causing the automated assistant 115 to initiate the automated telephone call. Further, the call initiation engine 170 can determine to generate and render (e.g., audibly and/or visually at the client device 110) a notification including a certain reason 211 for why the automated assistant 115 did not initiate the automated telephone call. For instance, the notification including the certain reason 211 can indicate that the automated assistant 115 did not initiate the automated telephone call because the user requested the automated assistant 115 call to make a reservation at Hypothetical Café to make a reservation, but Hypothetical Café does not take reservations.

For the sake of example, and in contrast with the continuation of the previous example, further assume that Hypothetical Café does take reservations and the call initiation engine 170 determines to initiate the automated telephone call. In this example, the call timing engine 180 can leverage the data that was obtained to determine when to initiate the automated telephone call to determine an optimal call time 207 to initiate the automated telephone call. For instance, assume that the user provided the user request 201 at noon. Further assume that busy time statistics for Hypothetical Café indicate that noon is a busy time due to a lunch rush. In this instance, the call timing engine 180 can infer that it is unlikely that a representative of Hypothetical Café will answer the automated telephone call due to the lunch rush. Accordingly, the timing engine 180 can determine that the optimal call time 207 is in two hours after the lunch rush is over. Put another way, in this instance, the timing engine 180 can determine that the optimal call time 207 is not a current time as indicated at 208.

As a result, the call timing engine 180 can determine to generate and render (e.g., audibly and/or visually at the client device 110) a notification indicating delay 209 for when the automated assistant 115 will initiate the automated telephone call. The notification indicating delay 209 for when the automated assistant 115 will initiate the automated telephone call can optionally include a certain reason for why there is the delay in initiating the automated telephone call. In this example, the certain reason can indicate that Hypothetical Café is busy with the lunch rush, and it is less likely that a representative associated with Hypothetical Café will answer the automated telephone call, so the automated assistant 115 will wait until it is more likely that the representative associated with Hypothetical Café will answer the automated telephone call. Further assuming that a current time corresponds to the optimal call time 207, the automated assistant 115 can initiate the automated telephone call with Hypothetical Café (e.g., by obtaining a telephone number associated with Hypothetical Café and placing a call to the telephone number) and cause the conversation engine 190 to engage in a conversation 210 with a representative of Hypothetical Café to make the dinner reservation as requested.

Although the process flow 200 of FIG. 2 is described with respect to particular examples, it should be understood that those are examples are provided to illustrate techniques contemplated herein and are not meant to be limiting. Further, it should be understood that the operations described with respect to the call initiation engine 170 and the call timing engine 180 can be utilized in isolation and/or in combination as described herein.

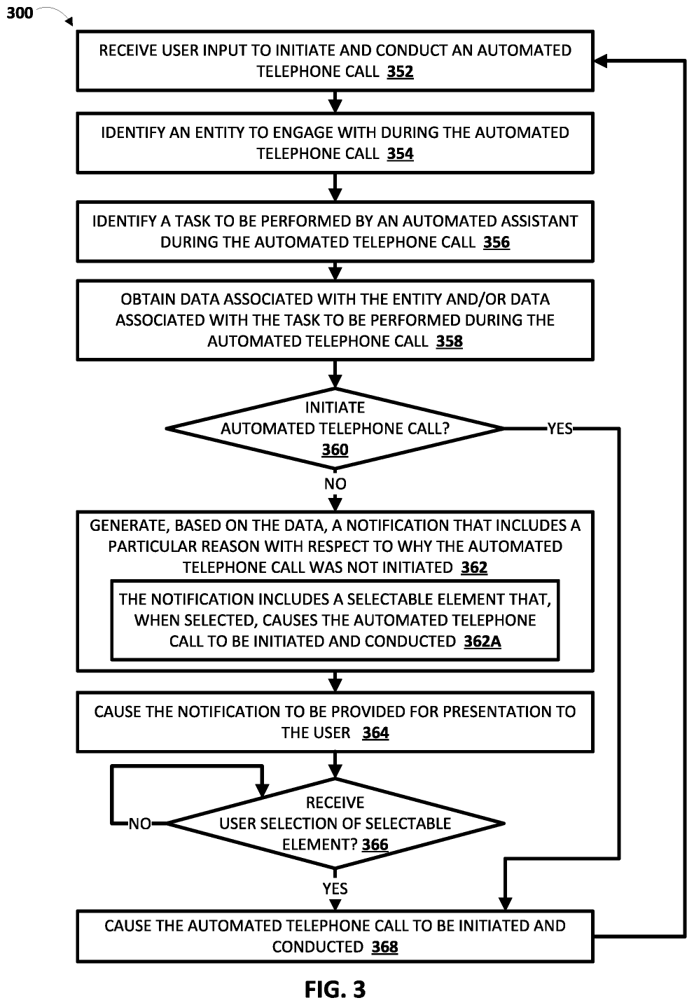

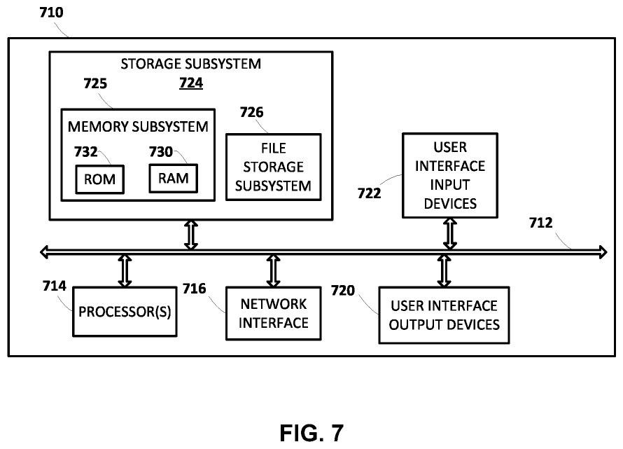

Turning now to FIG. 3, a flowchart illustrating an example method 300 of determining whether to initiate an automated telephone call is depicted. For convenience, the operations of the method 300 are described with reference to a system that performs the operations. This system of the method 300 includes at least one processor, memory, and/or other component(s) of computing device(s) (e.g., client device 110 of FIG. 1, automated telephone call system 120 of FIG. 1, computing device 710 of FIG. 7, and/or other computing devices). Moreover, while operations of the method 300 are shown in a particular order, this is not meant to be limiting. One or more operations may be reordered, omitted, and/or added.

At block 352, the system receives user input to initiate and conduct an automated telephone call. For example, the system can receive the user input as spoken input, typed input, touch input, and/or other forms of user input contemplated herein via the client device 110 (e.g., as described with respect to the user input engine 111 of FIG. 1).

At block 354, the system identifies an entity to engage with during the automated telephone call. For example, the system can cause the entity identification engine 150 to identify the entity for the automated assistant to engage with during the automated telephone call (e.g., as described with respect to the entity identification engine 150 of FIGS. 1 and 2).

At block 356, the system identifies a task to be performed by an automated assistant during the automated telephone call. For example, the system can cause the task identification engine 140 to identify the task for the automated assistant to perform during the automated telephone call (e.g., as described with respect to the task identification engine 140 of FIGS. 1 and 2).

At block 358, the system obtains data associated with the entity and/or data associated with the task to be performed during the automated telephone call. For example, the system can cause the data retrieval engine 160 to retrieve the data associated with the entity and/or the data associated with the task (e.g., as described with respect to the data retrieval engine 160 of FIGS. 1 and 2).

At block 360, the system determines whether to initiate the automated telephone call. For example, the system can cause the call initiation engine 170 to determine whether to initiate the automated telephone call based on the data associated with the entity and/or the data associated with the task (e.g., as described with respect to the call initiation engine 170 of FIGS. 1 and 2).

If, in an iteration of block 360, the system determines to initiate the automated telephone call, then the system proceeds to the operations of block 368. At block 368, the system causes the automated telephone call to be initiated and conducted. For example, the system can obtain a telephone number associated with the entity that was identified at the operations of block 354 and initiate the automated telephone call using the telephone number. Further, the system can cause the conversation engine 190 to engage in a conversation with a representative associated with the entity during the automated telephone call to perform the task that was identified at the operations of block 356. In some implementations, the system can cause a summary of the automated telephone call to be provided for presentation to the user. The system can return to the operations of block 352 and wait to receive additional user input to initiate and conduct an additional automated telephone call and perform an additional iteration of the method 300 of FIG. 3 with respect to the additional user input.

If, in an iteration of block 360, the system determines to not initiate the automated telephone call, then the system proceeds to the operations of block 362. At block 362, the system generates, based on the data (e.g., the data associated with the entity and/or the data associated with the task), a notification that includes a particular reason with respect to why the automated telephone call was not initiated. For example, the system can cause the call initiation engine 170 to generate the notification that includes the particular reason with respect to why the automated telephone call was not initiated and based on the data associated with the entity and/or the data associated with the task (e.g., as described with respect to the call initiation engine 170 of FIGS. 1 and 2).

In some implementations, block 362 may include sub-block 362A. In implementations where block 362 includes sub-block 362A, the system can, in generating the notification, include a selectable element that, when selected, causes the automated telephone call to be initiated and conducted. Put another way, the notification can optionally include the selectable element to enable a user (e.g., that provided the user input at the operations of block 352) to override the system's determination to not initiate the automated telephone call.

At block 364, the system causes the notification to be provided for presentation to the user. For example, the notification can be visually rendered and/or audibly rendered for presentation to the user (e.g., as described with respect to the rendering engine 112 of FIG. 1).

At block 366, and assuming that the notification includes the selectable element from the operations of sub-block 362A, the system determines whether a user selection of the selectable element has been received. Similar to the user input, the system can receive the user selection as spoken input, typed input, touch input, and/or other forms of user input contemplated herein via the client device 110 (e.g., as described with respect to the user input engine 111 of FIG. 1).

If, at an iteration of block 366, the system determines that no user selection of the selectable element has been received, then the system can wait for the user selection to be received. In some implementations, the system may only wait for the user selection for a threshold duration of time after the notification is rendered for presentation to the user (e.g., 10 seconds, 20 seconds, 60 seconds, etc.).

If, at an iteration of block 366, the system determines that the user selection of the selectable element has been received, then the system proceeds to the operations of block 368. As described above, at block 368, the system causes the automated telephone call to be initiated and conducted. The system can return to the operations of block 352 and wait to receive additional user input to initiate and conduct an additional automated telephone call and perform an additional iteration of the method 300 of FIG. 3 with respect to the additional user input.

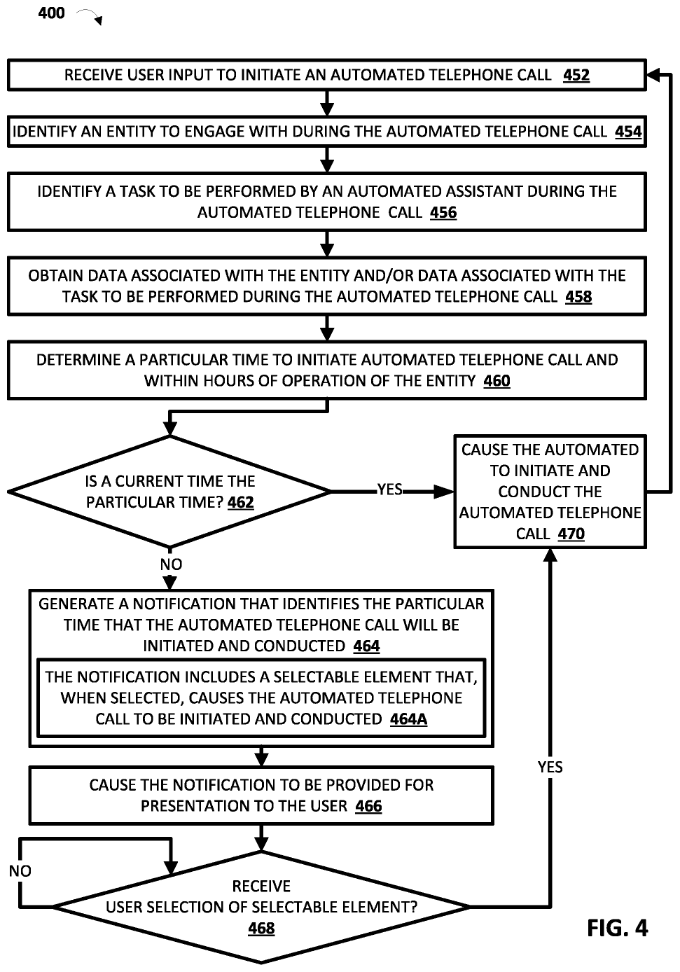

Although the method 300 of FIG. 3 is not described with respect to dynamically determining when to initiate an automated telephone call (e.g., as described with respect to FIGS. 2 and 4), it should be understood that is for the sake of example and is not meant to be limiting. Rather, it should be understood that the method 300 of FIG. 3 is described herein to illustrate some techniques contemplated herein. Further, although the method 300 of FIG. 3 includes the operations of block 366, it should be understood that those operations are included to illustrate implementations where sub-block 362A is included. However, in implementations where sub-block 362A is omitted, the system can return to the operations of block 352 from the operations of block 364.

Turning now to FIG. 4, a flowchart illustrating an example method 400 of dynamically determining when to initiate an automated telephone call is depicted. For convenience, the operations of the method 400 are described with reference to a system that performs the operations. This system of the method 400 includes at least one processor, memory, and/or other component(s) of computing device(s) (e.g., client device 110 of FIG. 1, automated telephone call system 120 of FIG. 1, computing device 710 of FIG. 7, and/or other computing devices). Moreover, while operations of the method 400 are shown in a particular order, this is not meant to be limiting. One or more operations may be reordered, omitted, and/or added.

At block 452, the system receives user input to initiate an automated telephone call. At block 454, the system identifies an entity to engage with during the automated telephone call. At block 456, the system identifies a task for an automated assistant to perform during the automated telephone call. At block 458, the system obtains data associated with the entity and/or data associated with the task to be performed during the automated telephone call. The operations of blocks 452-458 of the method 400 of FIG. 4 can be performed in the same or similar manner as described with respect to the operations of blocks 352-358 of the method 300 of FIG. 3, respectively.

At block 460, the system determines a particular time to initiate the automated telephone call and within hours of operation of the entity. For example, the system can cause the call timing engine 180 to determine the particular time to initiate the automated telephone call and within the hours of operation of the entity (e.g., as described with respect to the call timing engine 180 of FIGS. 1 and 2). Notably, if the user input is received while the hours of operation of the entity indicate that the entity is not open, the particular time does not necessarily correspond to a time when the entity subsequently is open. Rather, the particular time that is determined considers other data (e.g., busy time statistics or the like) that is in addition to the hours of operation of the entity to determine the particular time.

At block 462, the system determines if a current time is the particular time that was determined at the operations of block 460. If, in an iteration of block 462, the system determines that the current time is the particular time, then the system proceeds to the operations of block 470. At block 470, the system causes the automated telephone call to be initiated and conducted. For example, the system can obtain a telephone number associated with the entity that was identified at the operations of block 454 and initiate the automated telephone call using the telephone number. Further, the system can cause the conversation engine 190 to engage in a conversation with a representative associated with the entity during the automated telephone call to perform the task that was identified at the operations of block 456. In some implementations, the system can cause a summary of the automated telephone call to be provided for presentation to the user. The system can return to the operations of block 452 and wait to receive additional user input to initiate and conduct an additional automated telephone call and perform an additional iteration of the method 400 of FIG. 4 with respect to the additional user input.

If, in an iteration of block 462, the system determines that the current time is not the particular time, then the system can proceed to the operations of block 464. At block 464, the system generates, based on the particular time, a notification that identifies the particular time that the automated telephone call will be initiated and conducted. In some implementations, the notification can further include a particular reason with respect to why the automated telephone call will be initiated and conducted at the particular time. For example, the system can cause the call timing engine 180 to generate the notification that includes the particular time and optionally the particular reason with respect to why the automated telephone call will be initiated and conducted at the particular time (e.g., as described with respect to the call timing engine 180 of FIGS. 1 and 2).

In some implementations, block 464 may include sub-block 464A. In implementations where block 464 includes sub-block 464A, the system can, in generating the notification, include a selectable element that, when selected, causes the automated telephone call to be initiated and conducted. Put another way, the notification can optionally include the selectable element to enable a user (e.g., that provided the user input at the operations of block 352) to override the system's determination to wait for the particular time to initiate and conduct the automated telephone call (e.g., if the current time is not the particular time).

At block 466, the system causes the notification to be provided for presentation to the user. For example, the notification can be visually rendered and/or audibly rendered for presentation to the user (e.g., as described with respect to the rendering engine 112 of FIG. 1).

At block 468, and assuming that the notification includes the selectable element from the operations of sub-block 464A, the system determines whether a user selection of the selectable element has been received. Similar to the user input, the system can receive the user selection as spoken input, typed input, touch input, and/or other forms of user input contemplated herein via the client device 110 (e.g., as described with respect to the user input engine 111 of FIG. 1).

If, at an iteration of block 468, the system determines that no user selection of the selectable element has been received, then the system can wait for the user selection to be received. In some implementations, the system may only wait for the user selection for a threshold duration of time after the notification is rendered for presentation to the user (e.g., 10 seconds, 20 seconds, 60 seconds, etc.).

If, at an iteration of block 468, the system determines that the user selection of the selectable element has been received, then the system proceeds to the operations of block 470. As described above, at block 470, the system causes the automated telephone call to be initiated and conducted. The system can return to the operations of block 452 and wait to receive additional user input to initiate and conduct an additional automated telephone call and perform an additional iteration of the method 400 of FIG. 4 with respect to the additional user input.

Although the method 400 of FIG. 4 is not described with respect to determining whether to initiate an automated telephone call (e.g., as described with respect to FIGS. 2 and 3), it should be understood that is for the sake of example and is not meant to be limiting. Rather, it should be understood that the method 400 of FIG. 4 is described herein to illustrate some techniques contemplated herein. Further, although the method 400 of FIG. 4 includes the operations of block 468, it should be understood that those operations are included to illustrate implementations where sub-block 464A is included. However, in implementations where sub-block 464A is omitted, the system can return to the operations of block 462 from the operations of block 466 and wait until the current time is the particular time to initiate and conduct the automated telephone call.

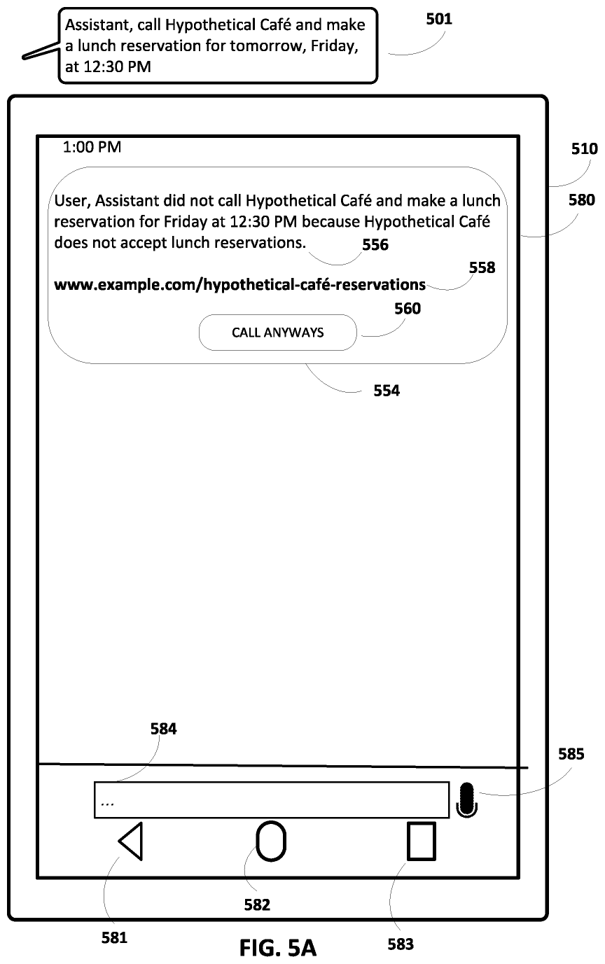

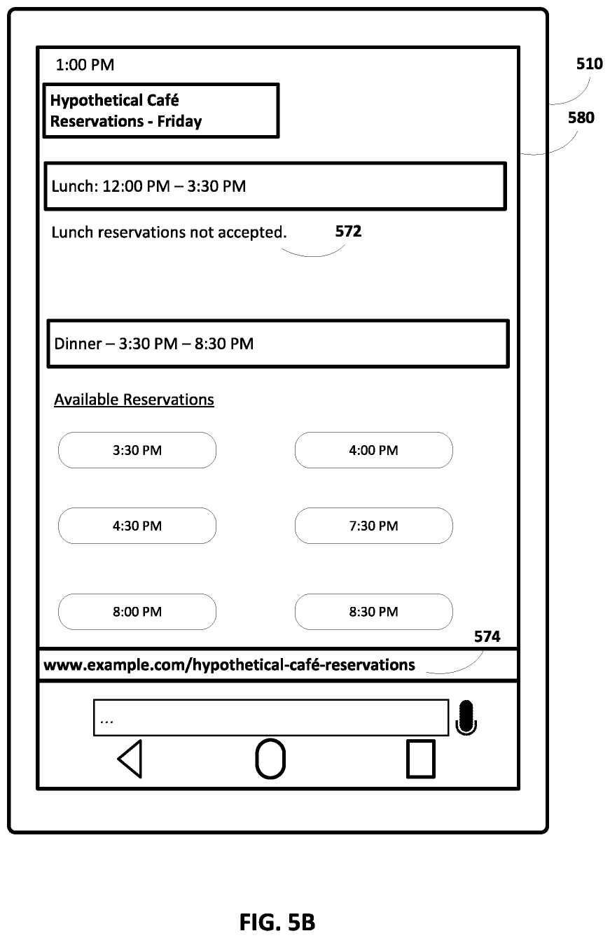

Turning now to FIGS. 5A and 5B, various non-limiting examples of determining whether to initiate an automated telephone call are depicted. FIGS. 5A and 5B each depict a client device 510 (e.g., an instance of the client device 110 from FIG. 1) having a display 580. One or more aspects of an automated assistant associated with the client device 510 (e.g., an instance of the automated assistant 115 from FIG. 1) may be implemented locally on the client device 510 and/or on other computing device(s) that are in network communication with the client device 510 in a distributed manner (e.g., via network(s) 199 of FIG. 1). For the sake of simplicity, operations of FIGS. 5A and 5B are described herein as being performed by the automated assistant. Although the client device 510 of FIGS. 5A and 5B is depicted as a mobile phone, it should be understood that is not meant to be limiting. The client device 510 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 580 of the client device 510 in FIGS. 5A and 5B further includes a textual input interface element 584 that the user may select to generate user input via a keyboard (virtual or real) or other touch and/or typed input, and a spoken input interface element 585 that the user may select to generate user input via microphone(s) of the client device 510. In some implementations, the user may generate user input via the microphone(s) without selection of the spoken input interface element 585. For example, active monitoring for audible user input via the microphone(s) may occur to obviate the need for the user to select the spoken input interface element 585. In some of those and/or in other implementations, the spoken input interface element 585 may be omitted. Moreover, in some implementations, the textual input interface element 584 may additionally and/or alternatively be omitted (e.g., the user may only provide audible user input). The display 580 of the client device 510 in FIGS. 5A and 5B also includes system interface elements 581, 582, 583 that may be interacted with by the user to cause the client device 510 to perform one or more actions.

Referring specifically to FIG. 5A, for the sake of example assume that a user of the client device 510 provides user input 501 of “Assistant, call Hypothetical Café and make a lunch reservation for tomorrow, Friday, at 12:30 PM”. In this example, the automated assistant can identify the task to be performed based on the user input 501 as: (1) call “Hypothetical Café”; and (2) make a lunch reservation for tomorrow, Friday at 12:30 PM. Further, the automated assistant can identify the entity to be engaged with during the automated telephone call based on the user input 501 as “Hypothetical Café”.

Referring briefly to FIG. 5B and continuing with the example of FIG. 5A, the automated assistant can access entity data associated with Hypothetical Café. The entity data can be any identifying data associated with the entity such as a phone number, website address, and/or email address. In the example of FIG. 5B, the entity data is a website address www.example.com/hypothetical-cafe-reservations 574 associated with the entity—Hypothetical Café. Further, the automated assistant may also obtain task data associated with the task to be performed during the automated telephone call. In the example of FIG. 5B, the task data is “Lunch Reservations not accepted” 572. Based on the entity data and/or the task data, the automated assistant can determine whether to initiate the automated phone call. Accordingly, in the example of FIG. 5B, because the task data indicates that Hypothetical Café does not accept lunch reservations, the automated assistant can determine to not initiate the automated telephone call.

Referring back to FIG. 5A, and based on determining to not initiate the automated telephone call, the automated assistant can generate and render a notification 554 for presentation to the user. In various implementations, the notification 554 can include a particular reason with respect to why the automated assistant did not initiate the automated telephone call as indicated by 556, a corresponding link 558 to a source of the task data and/or entity data, and/or a selectable element 560 that, when selected, causes the automated assistant to initiate and conduct the automated telephone call.

In some implementations the notification 554 can be a visual notification as depicted in FIG. 5A via the display 580. In additional or alternative implementations, the notification 554 can be an audible notification rendered via one or more speakers of the client device 510. In additional or alternative implementations, the notification 554 can be rendered both visually and audibly.

Notably, FIGS. 5A and 5B depict an example in which the automated assistant determines not to initiate the automated telephone call. Alternatively, the automated assistant may determine to initiate the automated telephone call based on the task data and/or the entity data. For example, if the user request 501 had been “Assistant, call Hypothetical Café and make a Dinner reservation for tomorrow, Friday, at 7:30 PM”, the automated assistant can initiate the automated phone call and make a reservation for Friday at 7:30 based on available reservations depicted in FIG. 5B indicating Hypothetical Café has availability at that time. In doing so, the automated assistant can bypass presenting the notification 554 to the user and initiate and conduct the automated telephone call.

Although the example of FIGS. 5A and 5B are described with respect to determining whether to initiate an automated telephone call, it should be understood that is for the sake of example and is not meant to be limiting. Rather, it should be understood that the example of FIGS. 5A and 5B is provided to illustrate various techniques contemplated herein (e.g., as described with respect to FIGS. 2 and 3) and that those techniques can be combined with other techniques described herein.

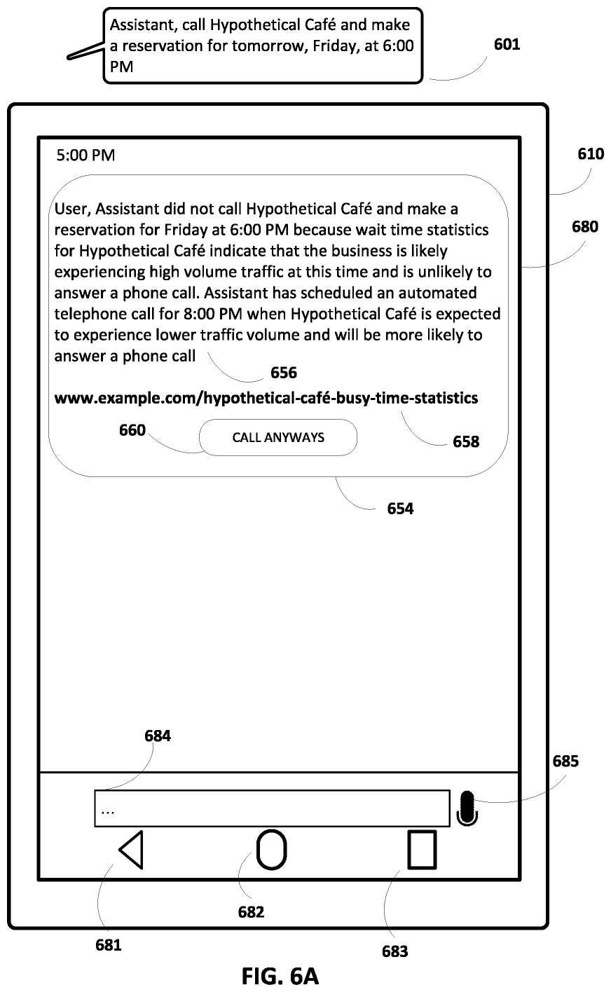

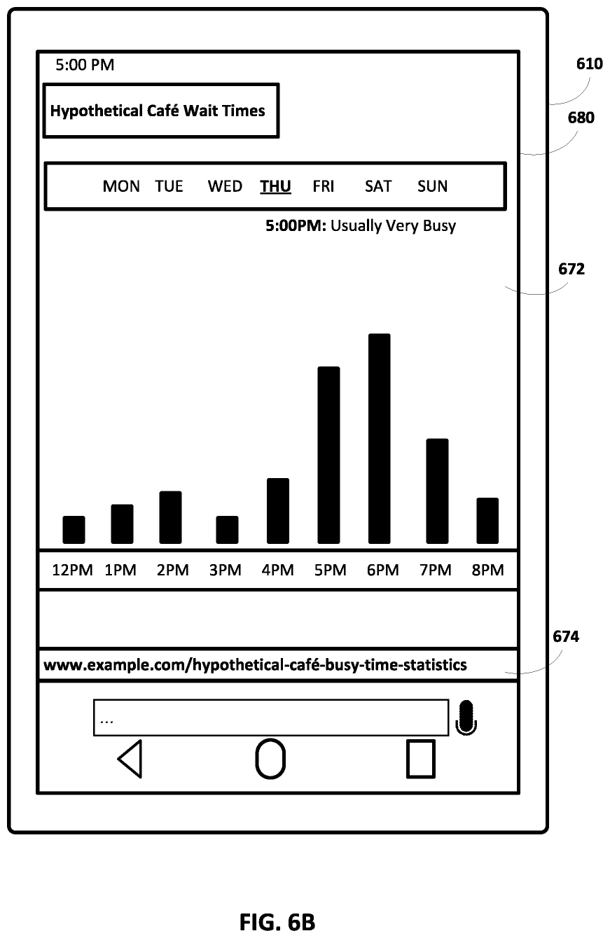

Turning now to FIGS. 6A and 6B, various non-limiting examples of dynamically determining when to initiate an automated telephone call are depicted. FIGS. 6A and 6B each depict a client device 610 (e.g., an instance of the client device 110 from FIG. 1) having a display 680. One or more aspects of an automated assistant associated with the client device 610 (e.g., an instance of the automated assistant 115 from FIG. 1) may be implemented locally on the client device 110 and/or on other client device(s) that are in network communication with the client device 110 in a distributed manner (e.g., via network(s) 199 of FIG. 1). For the sake of simplicity, operations of FIGS. 6A and 6B are described herein as being performed by the automated assistant. Although the client device 610 of FIGS. 6A and 6B is depicted as a mobile phone, it should be understood that is not meant to be limiting. The client device 610 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 680 of the client device 610 in FIGS. 6A and 6B further includes a textual input interface element 684 that the user may select to generate user input via a keyboard (virtual or real) or other touch and/or typed input, and a spoken input interface element 685 that the user may select to generate user input via microphone(s) of the client device 610. In some implementations, the user may generate user input via the microphone(s) without selection of the spoken input interface element 685. For example, active monitoring for audible user input via the microphone(s) may occur to obviate the need for the user to select the spoken input interface element 685. In some of those and/or in other implementations, the spoken input interface element 685 may be omitted. Moreover, in some implementations, the textual input interface element 684 may additionally and/or alternatively be omitted (e.g., the user may only provide audible user input). The display 680 of the client device 110 in FIGS. 6A and 6B also include system interface elements 681, 682, 683 that may be interacted with by the user to cause the client device 610 to perform one or more actions.

Referring specifically to FIG. 6A, for the sake of example assume that a user of the client device 610 provides user input 601 of “Assistant, Call Hypothetical Café and make a reservation for tomorrow, Friday, at 6:00 PM”. In this example, the automated assistant can identify a task to be performed based on the user input 601 as: (1) call “Hypothetical Café”; and (2) make a reservation for tomorrow, Friday, at 6:00 PM. Further, the automated assistant can identify the entity to be engaged with during the automated telephone call based on the user input 601 as “Hypothetical Café”.

In response to receiving the user input 601 and identifying the task to be performed during the automated telephone call and the entity to be engaged with during the automated telephone call, the automated assistant can obtain task data and entity data. The entity data can be any identifying data, such as a website(s), phone number(s), email address, physical address, and/or other data associated with the entity. The task data can be any information associated with the identified task, which can vary greatly based on the user input 601 that is provided by the user.

Referring briefly to FIG. 6B and continuing with the example of FIG. 6A, the entity data can be the website address of www.example.com/hypothetical-café-busy-time-statistics 674. The task data can be identified as busy time statistics for Hypothetical Café. Notably, the task data indicates that Hypothetical Café is generally very busy around 5:00 PM (e.g., a current time at which the user provided the user input 601), but also indicates that Hypothetical Café is not as busy at 8:00 PM. Based on the entity data and/or the task data, the automated assistant can determine a particular time to initiate the call with the entity that is within hours of operation of Hypothetical Café but is not a current time since Hypothetical Café is very busy. The particular time can be an optimal time that is determined based on the task and/or entity data. For example, the automated assistant can determine not to initiate the call at 5:00 PM because Hypothetical Café is very busy at that time, and it is less likely to answer the phone. Instead, the automated assistant can determine to initiate and conduct the automated telephone call at 8:00 PM, when a representative from Hypothetical Café is more likely to answer since Hypothetical Café will not be as busy at that time as compared to the current time.

Based on the determination of the particular time to initiate the automated phone call, the automated assistant can initiate the automated phone call if the particular time is the current time. However, and as depicted in FIG. 6A, if the particular time is not the current time, the automated assistant can generate and render a notification 654 for presentation to the user. The notification 654 can be a visual notification, an audio notification, a haptic notification, or a combination thereof. The notification 654 can, for example, include an identification of the particular time that the automated telephone call will be initiated and conducted as indicated by 656, a corresponding link 658 to a source of the entity data and/or task data, and/or a selectable element 660 that, when selected, causes the automated assistant to initiate and conduct the automated telephone call at the current time.

For example, in FIG. 6A, the notification 654 indicates that the automated assistant determined that the particular time to initiate the automated phone call is 8:00 PM because Hypothetical Café is less busy at that time and more likely to result in the task being successfully performed. If a user were to provide input to interact with the selectable element 660, the automated assistant would initiate and conduct the automated telephone call at the current time of 5:00 PM. Otherwise, the automated assistant would wait until 8:00 PM to initiate and conduct the automated telephone call.

Although FIGS. 6A and 6B are described with respect to certain examples, it should be understood that those examples are described herein to illustrate various techniques contemplated herein and are not meant to be limiting. Rather, it should be understood that the techniques described herein can be adapted to different tasks that the user requests the automated assistant to perform.

Turning now to FIG. 7, a block diagram of an example computing device 710 that may optionally be utilized to perform one or more aspects of techniques described herein. In some implementations, one or more of a client device, remote system component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIGS. 1 and 2.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving user input to initiate an automated telephone call, the user input being received via a client device of a user, and the automated telephone call to be performed by an automated assistant that is accessible at least in part at the client device; identifying, based on the user input, an entity to engage with during the automated telephone call; identifying, based on the user input, a task to be performed by the automated assistant during the automated telephone call; obtaining, based on the entity to engage with during the automated telephone call and based on the task to be performed by the automated assistant during the automated telephone call, data that is associated with the entity to engage with during the automated telephone call and that is relevant to the task to be performed by the automated assistant during the automated telephone call; determining, based on the data that is associated with the entity to engage with during the automated telephone call and that is relevant to the task to be performed by the automated assistant during the automated telephone call, whether to initiate the automated telephone call or to refrain from initiating the automated telephone call; and in response to determining to refrain from initiating the automated telephone call: generating, based on the data that is associated with the entity to engage with during the automated telephone call and that is relevant to the task to be performed by the automated assistant during the automated telephone call, a notification that includes an indication of a certain reason with respect to why the automated assistant refrained from initiating the automated telephone call; and causing the notification to be rendered for presentation to the user via the client device.

These and other implementations of technology disclosed herein can optionally include one or more of the following features.

In some implementations, the notification may further include a selectable element that, when selected, causes the automated assistant to initiate and conduct the automated telephone call.

In some versions of those implementations, the method may further include: receiving a user selection of the selectable element, the user input being received via the client device of the user; and in response to receiving the user selection of the selectable element: causing the automated assistant to initiate the automated telephone call; and causing the automated assistant to conduct the automated telephone call.

In some further versions of those implementations, causing the automated assistant to initiate the automated telephone call may include: causing the automated assistant to obtain a telephone number associated with the entity to engage with during the automated telephone call; and causing the automated assistant to utilize the telephone number associated with the entity to engage with during the automated telephone call to initiate the automated telephone call.

In some yet further versions of those implementations, causing the automated assistant to conduct the automated telephone call may include: causing the automated assistant to render one or more corresponding instances of synthesized speech to perform the task during the automated telephone call.

In some even yet further versions of those implementations, the method may further include: determining, based on the automated assistant performing the task during the automated telephone call, a result of performance of the task; generating, based on the result of performance of the task, an additional notification; and causing the additional notification to be rendered for presentation to the user via the client device.

In some implementations, the notification may further include a selectable link that, when selected, causes the automated assistant to navigate to a corresponding source of the data that is associated with the entity to engage with during the automated telephone call and that is relevant to the task to be performed by the automated assistant during the automated telephone call.

In some versions of those implementations, the method may further include: receiving a user selection of the selectable link, the user input being received via the client device of the user; and in response to receiving the user selection of the selectable link: causing the automated assistant to navigate to the corresponding source of the data that is associated with the entity to engage with during the automated telephone call and that is relevant to the task to be performed by the automated assistant during the automated telephone call.

In some further versions of those implementations, the automated assistant may navigate to the corresponding source of the data, that is associated with the entity to engage with during the automated telephone call and that is relevant to the task to be performed by the automated assistant during the automated telephone call, using a web browser software application or a navigation software application.

In some implementations, obtaining the data that is associated with the entity to engage with during the automated telephone call and that is relevant to the task to be performed by the automated assistant during the automated telephone call based on the entity to engage with during the automated telephone call and based on the task to be performed by the automated assistant during the automated telephone call may include: causing the automated assistant to search, over one or more databases, for entity data associated with the entity to engage with during the automated telephone call; and causing the automated assistant to search, over the entity data included in one or more of the databases, for task data that is specific to the entity and that is relevant to the task to be performed by the automated assistant during the automated telephone call.

In some implementations, the data that is associated with the entity to engage with during the automated telephone call and that is relevant to the task to be performed by the automated assistant during the automated telephone call may include one or more of: busy time statistics associated with how long a busy is the entity is at a given time instance, wait time statistics associated with how long a wait associated with the entity is at the given time instance, pecuniary statistics associated with pecuniary information for the entity, hours of operation information that includes hours of operation of the entity for a given time period, review information that includes information about the entity that is provided by other users, or image information that includes images about the entity of the entity that is provided by other users.

In some implementations, the method may further include, in response to determining to initiate the automated telephone call: causing the automated assistant to initiate the automated telephone call; and causing the automated assistant to conduct the automated telephone call.

In some versions of those implementations, causing the automated assistant to initiate the automated telephone call may include, causing the automated assistant to obtain a telephone number associated with the entity to engage with during the automated telephone call; and causing the automated assistant to utilize the telephone number associated with the entity to engage with during the automated telephone call to initiate the automated telephone call.

In some further versions of those implementations, causing the automated assistant to conduct the automated telephone call may include causing the automated assistant to render one or more corresponding instances of synthesized speech to perform the task during the automated telephone call.

In some yet further versions of those implementations, the method may further include, determining, based on the automated assistant performing the task during the automated telephone call, a result of performance of the task; generating, based on the result of performance of the task, an additional notification; and causing the additional notification to be rendered for presentation to the user via the client device.

In some implementations, causing the notification to be rendered for presentation to the user via the client device may include causing the notification to be visually rendered via a display of the client device.

In some implementations, causing the notification to be rendered for presentation to the user via the client device may include causing the notification to be audibly rendered via one or more speakers of the client device.

In some implementations, a method implemented by one or more processors is provided, and includes: receiving user input to initiate an automated telephone call, the user input being received via a client device of a user, and the automated telephone call to be performed by an automated assistant that is accessible at least in part at the client device; identifying, based on the user input, an entity to engage with during the automated telephone call; identifying, based on the user input, a task to be performed by the automated assistant during the automated telephone call; obtaining, based on the entity to engage with during the automated telephone call, hours of operation information that includes hours of operation of the entity for a given time period; obtaining, based on the entity to engage with during the automated telephone call, data that is associated with the entity to engage with during the automated telephone call and that is relevant to the task to be performed by the automated assistant during the automated telephone call; determining, based on the data that is associated with the entity to engage with during the automated telephone call and that is relevant to the task to be performed by the automated assistant during the automated telephone call, a given time instance to initiate the automated telephone call and within the hours of operation of the entity; and in response to determining that a current time instance corresponds to the given time instance: causing the automated assistant to initiate the automated telephone call; and causing the automated assistant to conduct the automated telephone call.

These and other implementations of technology disclosed herein can optionally include one or more of the following features.

In some implementations, the method may further include generating, based on the given time instance to initiate the automated telephone call and within the hours of operation of the entity, a notification that includes an indication of the given time instance; and causing the notification to be rendered for presentation to the user via the client device.

In some versions of those implementations, the method may further include determining, based on the automated assistant performing the task during the automated telephone call, a result of performance of the task; generating, based on the result of performance of the task, an additional notification; and causing the additional notification to be rendered for presentation to the user via the client device.

In some implementations, the data that is associated with the entity to engage with during the automated telephone call and that is relevant to the task to be performed by the automated assistant during the automated telephone call may be dependent on one or more of: an entity type of the entity, or a task type of the task.

In some implementations, obtaining the data that is associated with the entity to engage with during the automated telephone call and that is relevant to the task to be performed by the automated assistant during the automated telephone call based on the entity to engage with during the automated telephone call and based on the task to be performed by the automated assistant during the automated telephone call may include: causing the automated assistant to search, over one or more databases, for entity data associated with the entity to engage with during the automated telephone call; and causing the automated assistant to search, over the entity data included in one or more of the databases, for task data that is specific to the entity and that is relevant to the task to be performed by the automated assistant during the automated telephone call.

In some versions of those implementations, the data that is associated with the entity to engage with during the automated telephone call and that is relevant to the task to be performed by the automated assistant during the automated telephone call may include one or more of: busy time statistics associated with how long a busy is the entity is at a given time instance, wait time statistics associated with how long a wait associated with the entity is at the given time instance, pecuniary statistics associated with pecuniary information for the entity, hours of operation information that includes hours of operation of the entity for a given time period, review information that includes information about the entity that is provided by other users, or image information that includes images about the entity of the entity that is provided by other users.

In some implementations, the given time instance may be subsequent to a user input time instance that corresponds to when the user input to initiate the automated telephone call is received.

In some implementations, the automated telephone call may be performed asynchronously with respect to the user input being received.

In some implementations, causing the automated assistant to initiate the automated telephone call may include causing the automated assistant to obtain a telephone number associated with the entity to engage with during the automated telephone call; and causing the automated assistant to utilize the telephone number associated with the entity to engage with during the automated telephone call to initiate the automated telephone call.

In some versions of those implementations, causing the automated assistant to conduct the automated telephone call may include causing the automated assistant to render one or more corresponding instances of synthesized speech to perform the task during the automated telephone call.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving user input to initiate an automated telephone call, the user input being received via a client device of a user, and the automated telephone call to be performed by an automated assistant that is accessible at least in part at the client device;
identifying, based on the user input, an entity to engage with during the automated telephone call;
identifying, based on the user input, a task to be performed by the automated assistant during the automated telephone call;
obtaining, based on the entity to engage with during the automated telephone call and based on the task to be performed by the automated assistant during the automated telephone call, data that is associated with the entity to engage with during the automated telephone call and that is relevant to the task to be performed by the automated assistant during the automated telephone call;
determining, based on the data that is associated with the entity to engage with during the automated telephone call and that is relevant to the task to be performed by the automated assistant during the automated telephone call, whether to initiate the automated telephone call or to refrain from initiating the automated telephone call; and
in response to determining to refrain from initiating the automated telephone call:
generating, based on the data that is associated with the entity to engage with during the automated telephone call and that is relevant to the task to be performed by the automated assistant during the automated telephone call, a notification that includes an indication of a certain reason with respect to why the automated assistant refrained from initiating the automated telephone call; and
causing the notification to be rendered for presentation to the user via the client device.

2. The method of claim 1, wherein the notification further includes a selectable element that, when selected, causes the automated assistant to initiate and conduct the automated telephone call.

3. The method of claim 2, further comprising:
receiving a user selection of the selectable element, the user input being received via the client device of the user; and
in response to receiving the user selection of the selectable element:
causing the automated assistant to initiate the automated telephone call; and
causing the automated assistant to conduct the automated telephone call.

4. The method of claim 3, wherein causing the automated assistant to initiate the automated telephone call comprises:
causing the automated assistant to obtain a telephone number associated with the entity to engage with during the automated telephone call; and
causing the automated assistant to utilize the telephone number associated with the entity to engage with during the automated telephone call to initiate the automated telephone call.

5. The method of claim 4, wherein causing the automated assistant to conduct the automated telephone call comprises:
causing the automated assistant to render one or more corresponding instances of synthesized speech to perform the task during the automated telephone call.

6. The method of claim 5, further comprising:
determining, based on the automated assistant performing the task during the automated telephone call, a result of performance of the task;
generating, based on the result of performance of the task, an additional notification; and
causing the additional notification to be rendered for presentation to the user via the client device.

7. The method of claim 1, wherein the notification further includes a selectable link that, when selected, causes the automated assistant to navigate to a corresponding source of the data that is associated with the entity to engage with during the automated telephone call and that is relevant to the task to be performed by the automated assistant during the automated telephone call.

8. The method of claim 7, further comprising:
receiving a user selection of the selectable link, the user input being received via the client device of the user; and
in response to receiving the user selection of the selectable link:
causing the automated assistant to navigate to the corresponding source of the data that is associated with the entity to engage with during the automated telephone call and that is relevant to the task to be performed by the automated assistant during the automated telephone call.

9. The method of claim 8, wherein the automated assistant navigates to the corresponding source of the data, that is associated with the entity to engage with during the automated telephone call and that is relevant to the task to be performed by the automated assistant during the automated telephone call, using a web browser software application or a navigation software application.

10. The method of claim 1, wherein obtaining the data that is associated with the entity to engage with during the automated telephone call and that is relevant to the task to be performed by the automated assistant during the automated telephone call based on the entity to engage with during the automated telephone call and based on the task to be performed by the automated assistant during the automated telephone call comprises:
causing the automated assistant to search, over one or more databases, for entity data associated with the entity to engage with during the automated telephone call; and
causing the automated assistant to search, over the entity data included in one or more of the databases, for task data that is specific to the entity and that is relevant to the task to be performed by the automated assistant during the automated telephone call.

11. The method of claim 1, wherein the data that is associated with the entity to engage with during the automated telephone call and that is relevant to the task to be performed by the automated assistant during the automated telephone call comprises one or more of: busy time statistics associated with how long a busy is the entity is at a given time instance, wait time statistics associated with how long a wait associated with the entity is at the given time instance, pecuniary statistics associated with pecuniary information for the entity, hours of operation information that includes hours of operation of the entity for a given time period, review information that includes information about the entity that is provided by other users, or image information that includes images about the entity of the entity that is provided by other users.

12. The method of claim 1, further comprising:
in response to determining to initiate the automated telephone call:
causing the automated assistant to initiate the automated telephone call; and
causing the automated assistant to conduct the automated telephone call.

13. The method of claim 12, wherein causing the automated assistant to initiate the automated telephone call comprises:
causing the automated assistant to obtain a telephone number associated with the entity to engage with during the automated telephone call; and
causing the automated assistant to utilize the telephone number associated with the entity to engage with during the automated telephone call to initiate the automated telephone call.

14. The method of claim 13, wherein causing the automated assistant to conduct the automated telephone call comprises:
causing the automated assistant to render one or more corresponding instances of synthesized speech to perform the task during the automated telephone call.

15. The method of claim 14, further comprising:
determining, based on the automated assistant performing the task during the automated telephone call, a result of performance of the task;
generating, based on the result of performance of the task, an additional notification; and
causing the additional notification to be rendered for presentation to the user via the client device.

16. The method of claim 1, wherein causing the notification to be rendered for presentation to the user via the client device comprises:
causing the notification to be visually rendered via a display of the client device.

17. The method of claim 1, wherein causing the notification to be rendered for presentation to the user via the client device comprises:
causing the notification to be audibly rendered via one or more speakers of the client device.

18. A system comprising:
at least one hardware processor; and
memory storing instructions that, when executed, cause the at least one hardware processor to be operable to:
receive user input to initiate an automated telephone call, the user input being received via a client device of a user, and the automated telephone call to be performed by an automated assistant that is accessible at least in part at the client device;
identify, based on the user input, an entity to engage with during the automated telephone call;
identify, based on the user input, a task to be performed by the automated assistant during the automated telephone call;
obtain, based on the entity to engage with during the automated telephone call and based on the task to be performed by the automated assistant during the automated telephone call, data that is associated with the entity to engage with during the automated telephone call and that is relevant to the task to be performed by the automated assistant during the automated telephone call;
determine, based on the data that is associated with the entity to engage with during the automated telephone call and that is relevant to the task to be performed by the automated assistant during the automated telephone call, whether to initiate the automated telephone call or to refrain from initiating the automated telephone call; and
in response to determining to refrain from initiating the automated telephone call:
generate, based on the data that is associated with the entity to engage with during the automated telephone call and that is relevant to the task to be performed by the automated assistant during the automated telephone call, a notification that includes an indication of a certain reason with respect to why the automated assistant refrained from initiating the automated telephone call; and
cause the notification to be rendered for presentation to the user via the client device.

19. A non-transitory computer-readable storage medium storing instructions that, when executed, causes at least one hardware processor to perform operations, the operations comprising:
receiving user input to initiate an automated telephone call, the user input being received via a client device of a user, and the automated telephone call to be performed by an automated assistant that is accessible at least in part at the client device;
identifying, based on the user input, an entity to engage with during the automated telephone call;
identifying, based on the user input, a task to be performed by the automated assistant during the automated telephone call;
obtaining, based on the entity to engage with during the automated telephone call and based on the task to be performed by the automated assistant during the automated telephone call, data that is associated with the entity to engage with during the automated telephone call and that is relevant to the task to be performed by the automated assistant during the automated telephone call;
determining, based on the data that is associated with the entity to engage with during the automated telephone call and that is relevant to the task to be performed by the automated assistant during the automated telephone call, whether to initiate the automated telephone call or to refrain from initiating the automated telephone call; and
in response to determining to refrain from initiating the automated telephone call:
generating, based on the data that is associated with the entity to engage with during the automated telephone call and that is relevant to the task to be performed by the automated assistant during the automated telephone call, a notification that includes an indication of a certain reason with respect to why the automated assistant refrained from initiating the automated telephone call; and
causing the notification to be rendered for presentation to the user via the client device.
